(19) United States
(12) Patent Application Publication
(10) Pub. No.: US 2016/0305588 A1
(43) Pub. Date: Oct. 20, 2016

(54) FLEXIBLE CONNECTION ELEMENT FOR CONNECTING A FIRST DEVICE WITH A SECOND DEVICE, IN PARTICULAR SCALES COMPENSATOR

(71) Applicant: HECHT TECHNOLOGIE GmbH, Pfaffenhofen/Ilm (DE)

(72) Inventors: Jan HECHT, Pfaffenhofen/Ilm (DE); Erich GLOECKL, Hohenwart (DE); Harald LOHMEIER, Frickendorf (DE)

(73) Assignee: HECHT TECHNOLOGIE GmbH, Pfaffenhofen/Ilm (DE)

(21) Appl. No.: 15/130,231

(22) Filed: Apr. 15, 2016

(30) Foreign Application Priority Data
Apr. 17, 2015 (DE) 10 2015 207 073.5
Jun. 15, 2015 (DE) 10 2015 210 960.7

(51) Int. Cl. F16L 27/108; G01G 21/23

(52) U.S. Cl. CPC F16L 27/1085; G01G 21/23

(57) ABSTRACT

The invention relates to a flexible connection element, in particular a scales compensator (1), for connecting a first device with a second device and for passing through a bulk material from the first device into the second device, wherein the connection element (1) comprises:
a base body (2) defining a conveyance channel, the base body (2) having a first end portion (3) at which an inlet opening (30) is formed and which, in case of intended use of the flexible connection element (1), is attached to the first device such that the bulk material can enter the conveyance channel through the inlet opening (30), and a second end portion (4) at which an outlet opening (40) is formed and which, in case of intended use of the flexible connection element (1), is attached to the second device such that the bulk material can exit the conveyance channel through the outlet opening (40) into the second device, wherein
at least the first and/or the second end portion (3, 4) of the base body (2) is made of a flexible material and defines a flange (33, 43) which extends outwards in a radial direction and in which a respective reception space (31, 41) is defined which encircles the corresponding opening and in which a dimensionally stable stabilization element (32, 42) is inserted such that, in case of intended attaching of the corresponding end portion, a clamping force generated by a fastening element acts on the stabilization element.

The invention relates to a flexible connection element for connecting a first device with a second device and for passing through a bulk material from the first device into the second device. In particular, the invention relates to a corresponding scales compensator for connecting the first device with the second device and for passing through the bulk material from the first device into the second device.

Flexible connection elements for connecting two devices and for conveying a bulk material from the one device into the other device are known in the prior art.

For example, the document DE 20 2008 012 645 U1 discloses a scales compensator made of a flexible material, which is attached both to a device containing bulk material and a weighing device. The bulk material is guided by the device containing the bulk material through the scales compensator into the weighing device. The scales compensator is configured such that forces, which act on the device containing the bulk material, are not transmitted to the weighing device, whereby the distortion of measurement results is prevented.

In the document, for attaching the scales compensator to the mentioned devices, the possibility of providing separate connection elements such as tri-clamp connection elements at the inlet port and the outlet port of the scales compensator is exemplified.

These separate connection elements are either made of metal or plastics and can be cast on the scales compensator or mounted thereto by means of an adhesive.

The casting on of the connection elements or the mounting of the connection elements by means of the adhesive results in an increased expenditure in manufacturing and in the necessity of inevitably also replacing the connection element each time the scales compensator is replaced.

Furthermore, there is a concern that the connection between the connection element and the flexible material is at least partly loosened, and that bulk material accumulates in the correspondingly formed gap.

Against this background, the object of the present invention is to provide a flexible connection element, in particular a scales compensator, which allows for simplified manufacturing and handling.

This object is achieved by a connection element according to claim 1.

Preferred embodiments of the invention are defined by the dependent claims.

A flexible connection element for connecting a first device with a second device and for passing through and conveying, respectively, a bulk material from the first device into the second device according to the invention comprises a base body defining and determining, respectively, a conveyance channel and having (i) a first end portion at which an inlet opening is formed and which is, in case of intended use of the flexible connection element, attached to the first device such that the bulk material can enter the conveyance channel through the inlet opening, and (ii) a second end portion at which an outlet opening is formed and which is, in case of intended use of the flexible connection element, attached to the second device such that the bulk material can exit the conveyance channel through the outlet opening into the second device.

In other words, in case of intended use of the flexible connection element, the second end portion is attached to the second device such that the bulk material can exit the conveyance channel through the outlet opening and enter the second device.

At least the first and/or second end portion of the base body is made of a flexible material and defines and determines, respectively, a respective flange, which extends outwards in a radial direction, and in which a respective reception space is defined and determined, respectively, which encircles and circumscribes, respectively, the corresponding opening, and in which a dimensionally stable stabilization element is inserted such that, in case of an intended attaching of the corresponding end portion, a clamping force generated by a fastening element acts on the stabilization element.

The mentioned radial direction refers to the inlet opening and/or outlet opening, and corresponds to the direction which extends in the plane, in which the respective opening lies, outwards from a center of the respective opening.

The first and/or the second device can be a pipe, for example, which guides the bulk material, or a device in which the bulk material is stored or processed. The bulk material is, for example, a powder or a granular material.

The flexible connection element according to the invention is, for example, suitable as a pipe connection which is designated for connecting two pipes which guide the bulk material. After attaching the connection element to the two pipes, the bulk material can be guided through the conveyance channel from the one pipe into the other. Furthermore, the flexible connection element according to the invention is preferably also suited for connecting a device which processes the bulk material, such as a mill, with a pipe guiding the bulk material into the processing device or out of the processing device.

In particular, the flexible connection element is a scales compensator which is preferably attached on the one hand to a device containing the bulk material and on the other hand to a weighing device. After attaching the first and second end portion of the scales compensator according to the invention to the device containing the bulk material and the weighing device, the bulk material can be guided through the conveyance channel into the weighing device, where the corresponding weight can be measured. The scales compensator is configured and designed, respectively, such that forces, that act on the device containing the bulk material and that are generated therefrom, respectively, are not transmitted to the weighing device.

The respective reception space is preferably designed and configured, respectively, such that the stabilization element is preferably replaceable.

In particular, the first and/or second flange is preferably also configured such that, in case of intended attaching of the flange, a sealing attachment of the flexible connection element according to the invention is achieved.

The flexible material of which the first and/or second end portion of the base body is formed, is, for example, (i) a silicon such as an FDA-compliant silicon, which can be electrically conductive or electrically insulating, (ii) a natural or synthetic rubber, or (iii) an elastomer such as ethylene propylene diene rubber (EPDM), which is preferably also FDA-compliant and/or which can be electrically conductive or electrically insulating.

According to the invention, the respective flange which is defined and provided, respectively, at the corresponding first and/or second end portion, is formed of the flexible material and can therefore be easily formed during the production of the base body, for example during a casting process. Therefore, it is not necessary that separate flange connections formed of a metal or plastics are cast on the base body or adhered to the base body.

The respective flange formed of the flexible material is given the necessary stability which is, for example, necessary for a clamping connection, by means of the stabilization element inserted into the respective reception space. In particular, the flange formed of the flexible material is constructed such that it can be abutted on a corresponding connection flange formed at the first or second device and attached by mounting a clamp which presses the flange and the connection flange against each other.

This kind of connection is known as Tri-clamp connection or Tri-clever connection, for example. That is, although the flange of the flexible connection element according to the invention is made of a flexible material, the mentioned conventional connection technology can be used for attaching the connection element and the scales compensator, respectively, according to the invention, because after inserting the stabilization element into the respective reception space, the flange is given the stiffness necessary for this kind of connection.

The respective flange formed of the flexible material and formed at the first and/or second end portion preferably comprises an insertion opening which points in the radial direction and through which an annular stabilization element forming the dimensionally stable stabilization element is inserted in the respective reception space.

The annular stabilization element is inserted in the respective reception space by deforming the respective flange in the radial direction and, for inserting the annular stabilization element, restoring its non-deformed form and shape, respectively.

More preferably, the insertion opening points outwards in the radial direction. That is, the insertion opening is located at an outer surface of the base body, and the annular stabilization element is preferably inserted in the reception space by deforming the flange such that its diameter and the inner diameter of the corresponding opening, respectively, is reduced, passing the annular stabilization element over the flange and, thereafter, restoring the non-deformed state of the flange, whereby the annular stabilization element is received through the insertion opening in the reception space.

This kind of configuration and arrangement of the insertion opening is in particular advantageous in that an inner surface of the base body, which defines the conveyance channel, has no transitions at which the bulk material may accumulate.

However, alternatively, the insertion opening may be provided at the inner surface of the base body and flange, respectively. In this case, the flange is expanded and put over the annular stabilization element.

The entire base body of the flexible connection element according to the invention is preferably made of the flexible material, wherein the respective flange is defined and formed, respectively, at the first and second end portion, and the respective stabilization element is inserted in the respective reception space.

By means of this construction of the base body of the flexible connection element according to the invention, the manufacturing process is very easy, because only the base body needs to be formed, for example by casting. Hence, it is not necessary to cast on connection elements. Furthermore, by means of this construction of the base body, a replacement of the flexible connection element according to the invention is very easy. It is only necessary to remove the annular stabilization elements from the reception spaces formed in the flanges of the connection element to be replaced, and to insert them in the reception spaces of the new connection element.

The flexible connection element according to the invention preferably comprises the annular stabilization element, which is preferably inserted in the respective reception space so as to be replaceable, wherein the annular stabilization element extends in the respective flange in the radial direction such that it is located between a face of the respective flange, which abuts on a connection flange formed on the respective first or second device, in case of intended attaching of the first and/or second end portion, and a surface of the respective flange, which faces away from the face. In case of intended attaching the respective flange to the connection flange by means of a clamp, for example a tri-clamp clamp, the clamping force generated by the clamp acts on the annular stabilization element.

The stabilization element inserted in the reception space is made of a rigid, stiff material. Examples of the rigid, stiff material include plastics or metals and metal alloys, respectively.

The flexible connection element according to the invention preferably further includes an other annular stabilization element which at least abuts on the surface of the respective flange, which faces away from the face, wherein, in case of the intended attaching of the respective flange to the connection flange of the corresponding device, the clamp directly abuts on the other annular stabilization element.

The other annular stabilization element is preferably formed to have a bending such that a section thereof abuts on the surface, which faces away from the face, of the respective flange and such that by means of its bending an other section extends parallel to an outer surface of an area, subsequent to the respective flange, of the base body.

The other annular stabilization element is preferably also replaceable, namely by, for example, putting the other annular stabilization element over the base body or by detaching the other annular stabilization element from the base body before the corresponding stabilization element is inserted in the reception space.

Preferably, on the face of the respective flange, an elevation is formed which encircles and circumscribes, respectively, the corresponding opening, wherein, in case of intended attaching of the respective flange by means of the clamp, the elevation sits in a corresponding recess formed in the connection flange and acts as a seal.

Alternatively, in the face of the flange, a recess is preferably formed which encircles and circumscribes, respectively, the corresponding opening, wherein, in case of intended attaching of the respective flange by means of the clamp, a corresponding elevation formed at the connection flange sits in the recess and acts as a seal.

Furthermore, the invention relates to a method of producing a base body for a flexible connection element for connecting a first device with a second device and for passing through and conveying, respectively, a bulk material from the first device into the second device, wherein the base body comprises:

a first end portion at which an inlet opening is formed and which is, in case of intended use of the flexible connection element, attached to the first device such that the bulk material can enter the conveyance channel through the inlet opening, and

a second end portion at which an outlet opening is formed and which is, in case of intended use of the flexible connection element, attached to the second device such that the bulk material can exit the conveyance channel through the outlet opening into the second device, wherein
the first and the second end portion of the base body are made of a flexible material and each of the first end portion and the second end portion defines and determines, respectively, a flange extending outwards in a radial direction, wherein in each of the flanges a reception space, which encircles and circumscribes, respectively, the corresponding opening, is defined and determined, respectively, and in which a dimensionally stable stabilization element can be replaceable and changeably, respectively, inserted such that, in case of intended attaching of the corresponding end portion, a clamping force generated by a fastening means acts on the stabilization element.

The method according to the invention comprises a forming step, in which the base body is completely formed of the flexible material, for example, by means of casting, such that the respective reception space is formed at the first and second end portion, in which the respective stabilization element can be inserted through a respective insertion opening.

Hereinafter, a preferred embodiment of the invention will be described with reference to the accompanying drawings.

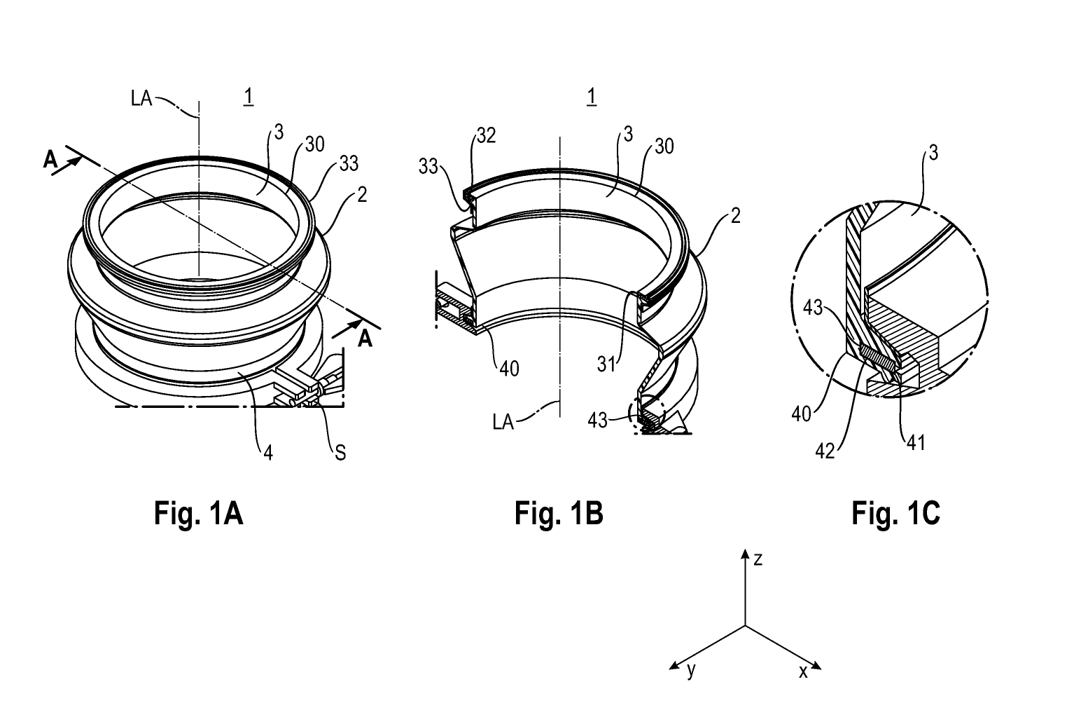

FIG. 1A shows a perspective view of a flexible connection element according to the invention, in particular of a scales compensator according to the invention, wherein a clamp provided for attaching the scales compensator is arranged at a second end portion of the scales compensator;

FIG. 1B shows a perspective longitudinal section of the scales compensator shown in FIG. 1A;

FIG. 1C shows an enlarged view of the encircled area IC of FIG. 1B;

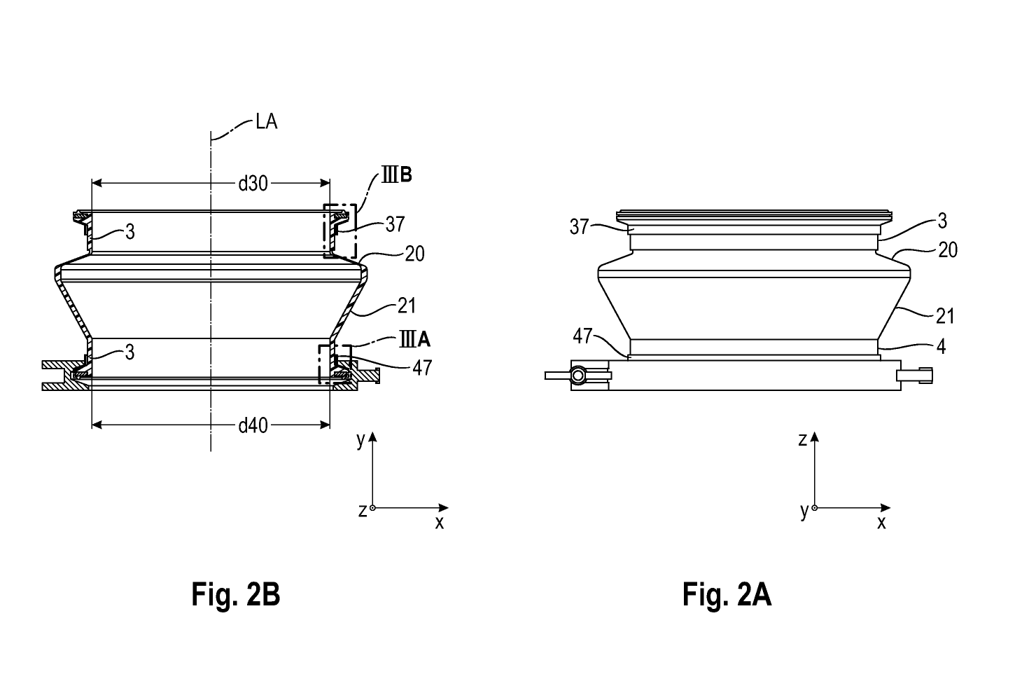

FIG. 2A shows a side view of the scales compensator according to the invention;

FIG. 2B shows a side view of the scales compensator according to the invention in a longitudinal section;

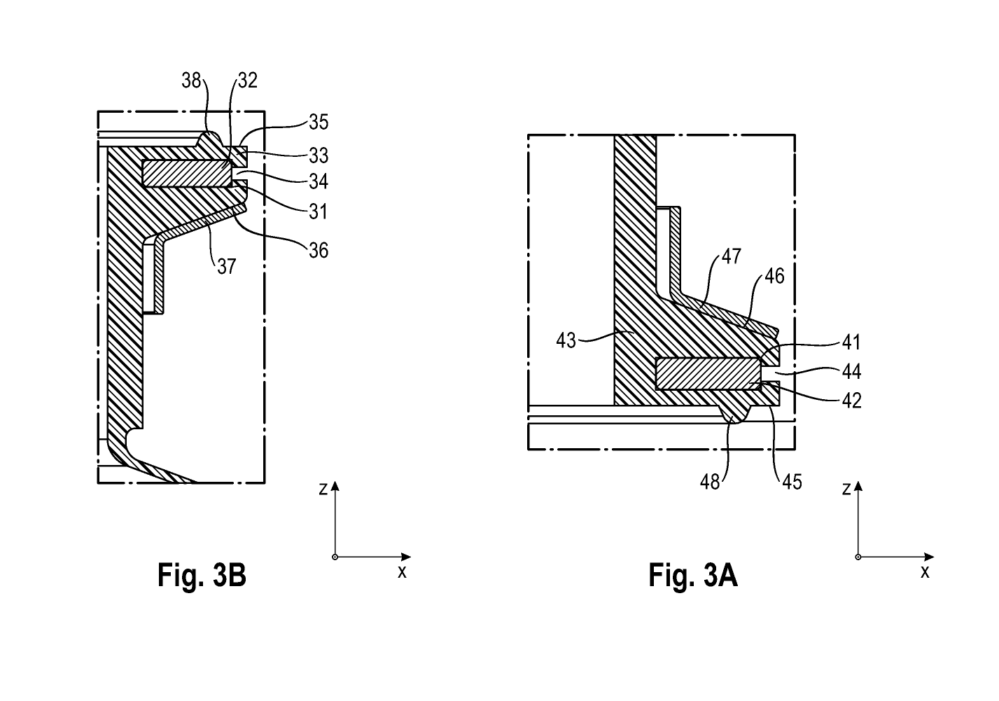

FIGS. 3A and 3B respectively show an enlarged view of the marked areas IIIA and IIIB in FIG. 2B.

FIG. 1A shows a preferred embodiment of a flexible connection element 1 according to the invention, in particular of a scales compensator according to the invention.

The Z-axis shown in FIG. 1A points in a longitudinal direction of the scales compensator 1 according to the invention, along which the longitudinal axis LA of the scales compensator 1 extends.

The X-axis shown in FIG. 1A points in a width direction of the scales compensator 1, and the Y-axis shown in FIG. 1A points in a depth direction of the scales compensator 1. Due to the rotational symmetry of the scales compensator 1 with respect to the longitudinal axis LA, the width direction and the depth direction correspond to radial directions in which the scales compensator 1 extends in its width and depth.

The scales compensator 1 comprises a base body 2 which is formed and made, respectively, of a flexible material. The flexible material is, for example, (i) a silicon such as an FDA-compliant silicon, which can be electrically conductive or electrically insulating, (ii) natural or synthetic rubber, or (iii) an elastomer such as ethylene propylene diene rubber (EPDM), which is preferably also FDA-compliant and which can be electrically conductive or electrically insulating. The base body 2 is in particular an article formed of a flexible material, for example an article cast from a flexible material.

An inlet opening 13 is formed at a first end portion 3 of the base body 2, and an outlet opening 40 is formed at a second end portion 4 of the base body 2. The scales compensator 1 according to the invention is, in case of intended use, mounted by attaching the first end portion 3 to a first device (not shown) and attaching the second end portion 4 to a second device (not shown).

The first device is preferably a device that stores/accommodates/contains/processes a bulk material, and the second device is preferably a weighing device. The bulk material is, for example, a powder or a granular material.

When the scales compensator 1 according to the invention is attached to the first device and the second device, the bulk material can enter a conveyance channel defined by the base body 2 through the inlet opening 30 and, thereafter, exit the conveyance channel through the outlet opening 40 into the second device. In general terms, the bulk material can be guided from the device, which stores, accommodates, contains or processes the bulk material, through the scales compensator to the weighing device, where the weight of the transferred bulk material can be determined.

A respective clamp S, which serves for attaching the scales compensator 1 according to the invention to the first device and to the second device, is placed around the respective end portion 3, 4 and tightened by means of a butterfly screw. In FIG. 1A, the clamp S is applied to the second end portion 4 of the scales compensator 1 for attaching the second end portion 4 to the second device which is not shown. The first end portion 3 can be attached to the corresponding first device in the same manner using an other clamp S.

The clamps suited for attaching are generally known in the prior art from vacuum technology as Tri-clamp clamps or Tri-clever clamps.

FIG. 1B shows a perspective sectional view of the scales compensator 1 according to the invention, wherein the sectional view corresponds to a section along the cutting line A-A shown in FIG. 1A, and the cutting plane corresponds to the Z-X-plane shown in FIG. 1B.

In FIG. 1C, the encircled area IC of FIG. 1B is shown enlarged.

As can be gathered from these Figures, a flange 43 is formed at the second end portion 4 of the scales compensator 1, wherein the flange 43 encircles and circumscribes, respectively, the outlet opening 40 and is received in a corresponding groove of the clamp S. A corresponding connection flange (not shown) is formed at the second device for attaching the scales compensator 1 according to the invention. When the clamp S is applied for attaching the scales compensator 1, the flange 43 and the corresponding connection flange are arranged together inside the groove of the clamp S and are sealingly pressed against each other by tightening the butterfly screw.

A corresponding flange 33 is also formed at the first end portion 3 of the scales compensator 1, which can be attached to the first device with a corresponding clamp S in the same manner as the flange 43 formed at the second end portion 4. As an integral part of the base body 2, each flange 33, 43 is made of the flexible material.

For providing the respective flange 33, 43 with a stability necessary for the attaching, a reception space 31, 41 is formed in each flange 33, 43, wherein each reception space 31, 41 encircles and circumscribes, respectively, the corresponding opening, and wherein an annular stabilization element 32, 42 is received in each reception space 31, 41. The respective stabilization element 32, 42 can be made of metal or plastics, for example.

In the FIGS. 2A and 2B, a side view of the scales compensator 1 according to the invention is shown, wherein FIG. 2B is a sectional view which corresponds to a section along the cutting line A-A shown in FIG. 1A.

The height of the scales compensator 1, which extends in the length direction (Z-direction), is preferably 130-150 mm. The inner diameters d30 and d40 of the inlet opening 30 and the outlet opening 40, respectively, of the scales compensator 1, which extend in the radial direction, are preferably identical and are preferably 190-210 mm.

In the range of the end portions 3, 4, the inner diameter d30, d40 of the base body 2 is constant.

Starting from the inlet opening 30, the base body 2 comprises an area 20 subsequent to the first end portion 3, in which the base body 2 is abruptly widened, and an area 21 subsequent to the area 20, in which the base body 2 is tapered again so as to finally reach the constant inner diameter d40 of the second end portion 4.

The area 20, in which the base body 2 is abruptly widened, has a lower wall thickness than the area 21 and the end portions 3, 4. The wall thickness of the area 20 is 1 mm, for example. Due to the lower wall thickness, this area 20 is formed flexible and more flexible, respectively, than the area 21 and the end portions 3, 4, respectively, whereby forces, which are generated by the first device and which act on the first end portion 30, result in a deformation of the area 20 and cannot be transferred via the scales compensator 1 to the second device—the weighing device—and hence cannot distort measurement results there.

With reference to the FIGS. 3A and 3B, the end portions 3, 4 of the scales compensator 1 according to the invention are henceforth explained in detail. FIG. 3A corresponds to the area marked with IIIA in FIG. 2B, and FIG. 3B corresponds to the area marked with IIIB in FIG. 2B.

As shown by these Figures, the respective flange 33, 43, which extends in the radial direction (X- and Y-direction), is formed at the first and the second end portion 3, 4. The respective flange 33, 43 is an integral part of the base body 2 and is formed during the production of the base body 2 together with the base body 2, for example. In this respect, the respective flange 33, 43 as well as the remaining base body 2 is formed of the flexible material such as silicon.

In each flange 33, 43, the mentioned reception space 31, 41 is defined and formed, respectively, wherein in each reception space 31, 41 a respective annular stabilization element 32, 42 is inserted.

Each flange 33, 43 is formed such that the respective reception space 31, 41 is accessible through an insertion opening 34, 44. The insertion opening 34, 44 is arranged in each flange 33, 43 such that it is located on an outer surface of the base body 2 and such that it points outwards in radial direction (X- and Y-direction).

For inserting the annular stabilization element 32, 42 in the respective reception space 31, 41, the base body 2 and the respective first or second end portion 3, 4, respectively, is deformed such that the diameter of the corresponding flange 33, 43 is reduced and, thereafter, the annular stabilization element 32, 42 is passed over the deformed end portion 3, 4. When the deformed end portion 3, 4 is returned from this state into its original form and position, respectively, the annular stabilization element can be pressed through the respective insertion opening 34, 44 in the respective reception space 31, 41.

The annular stabilization element 32, 42 has a rectangular form in the longitudinal section of the scales compensator according to the invention, i.e. in the Z-X-plane, wherein the width of the respective annular stabilization element in the shown X-direction (radial direction with respect to the longitudinal axis of the scales compensator 1) is 9 mm, for example, and the height of the respective annular stabilization element 32, 42 in the shown Z-direction is 3 mm, for example.

As can be gathered from a combination of the FIGS. 2B, 3A and 3B, in case of intended attaching, a face 35, 45 and an abutting surface 35, 45, respectively, of the respective flange 33, 43 is put on a corresponding surface area of the connection flange formed at the first or second device, and the flange 33, 43 as well as the connection flange are enclosed by the clamp S such that they are located inside the groove of the clamp S. By tightening the butterfly screw of the clamp S, the clamping force, with which the face 35, 45 of the respective flange is pressed against the corresponding surface area, is increased.

In each flange 33, 43, the respective reception space 31, 41 is formed such that the annular stabilization element 32, 42 is located between the respective face 35, 45 and a surface 36, 46 of the flange, which faces away from the corresponding face 35, 45. Hereby, the respective flange 33, 43 gets, by means of the respective stabilization element 32, 42, the stiffness necessary for mounting.

In addition to the annular stabilization element 32, 42 inserted into the respective reception space 31, 41, the scales compensator 1 according to the invention preferably comprises an other annular stabilization element 37, 47, which has a bent contour when seen in the longitudinal section shown in FIGS. 3A and 3B. The other annular stabilization element 37, 47 is also replaceable and made, for example, of a metal and a metal alloy, respectively, or of plastics. A section of the other annular stabilization element 37, 47 abuts on the respective surface 36, 46 of the respective flange 33, 43, which faces away from the face 35, 45, and an other section extends parallel to an outer surface, subsequent to the respective flange 33, 43 in the longitudinal direction, of the base body 2, wherein the other section is slightly spaced from the parallel outer surface of the base body 2.

When the clamp S is attached for attaching the respective flange, the clamp S lies directly on the other stabilization element 37, 47, as can be clearly seen from the FIGS. 1C and 2B.

The clamping force generated by the clamp S acts indirectly via the section of the other annular stabilization element 37, 47, which abuts on the surface 36, 46, which faces away from the respective face 35, 45, of the respective flange 33, 43, and the flexible material of the corresponding flange on the stabilization element inserted into the respective reception space 31, 41, by which in turn the respective face 35, 45 is pressed against the corresponding surface area of the connection flange which is formed on the first or second device.

An elevation 38, 48 is formed on the face 35, 45 of the respective flange 33, 43 such that the elevation 38, 48 encircles and circumscribes, respectively, the corresponding opening (inlet opening 30 or outlet opening 40). When the respective flange 33, 43 is applied to a corresponding connection flange for attaching, the elevation 38, 48 is dipped into a corresponding recess formed in the connection flange and acts, after tightening of the clamp S, as a corresponding seal.

The invention is not limited to the scales compensator 1 which has been previously described. In particular, the design of the first and second end portion can be transferred to common connection elements which are, for example, used as a pipe connection.

1. Flexible connection element, in particular scales compensator (1), for connecting a first device with a second device and for passing through a bulk material from the first device into the second device, wherein the connection element (1) comprises:
a base body (2) defining a conveyance channel, the base body (2) having a first end portion (3) at which an inlet opening (30) is formed and which, in case of intended use of the flexible connection element (1), is attached to the first device such that the bulk material can enter the conveyance channel through the inlet opening (30), and a second end portion (4) at which an outlet opening (40) is formed and which, in case of intended use of the flexible connection element (1), is attached to the second device such that the bulk material can exit the conveyance channel through the outlet opening (40) into the second device, wherein
at least the first and/or the second end portion (3, 4) of the base body (2) is made of a flexible material and defines a flange (33, 43) which extends outwards in a radial direction and in which a respective reception space (31, 41) is defined which encircles the corresponding opening and in which a dimensionally stable stabilization element (32, 42) is inserted such that, in case of intended attaching the corresponding end portion, a clamping force generated by a fastening element acts on the stabilization element.

2. Flexible connection element according to claim 1, wherein the respective reception space (31, 41) is defined such that the stabilization element (32, 42) is replaceable.

3. Flexible connection element, in particular scales compensator (1), according to claim 2, wherein
the respective flange (33, 43) made of the flexible material comprises an opening (34, 44) pointing in the radial direction, and an annular stabilization element (32, 42) forming the dimensionally stable stabilization element is inserted through the opening (34, 44) in the corresponding reception space (31, 41).

4. Flexible connection element, in particular scales compensator (1), according to claim 2, wherein the entire base body (2) is made of the flexible material, and
the respective flange (33, 43) is defined at the first and second end portion (3, 4), and the respective stabilization element is inserted in the respective reception space.

5. Flexible connection element, in particular scales compensator (1), according to claim 3, comprising the annular stabilization element (32, 42), which is inserted in the respective reception space (31, 41) so as to be replaceable, wherein
the annular stabilization element (32, 42) extends in the radial direction in the respective flange (33, 43) such that it is located between a face (35, 45) of the respective flange (33, 43), which abuts a connection flange formed at the corresponding device in case of intended attaching of the first and/or second end portion (3, 4), and a surface (36, 46) of the respective flange (33, 43), which faces away from the face (35, 45), such that, in case of intended attaching of the respective flange (33, 43) to the connection flange by means of a clamp, the clamping force generated by the clamp acts on the annular stabilization element (31, 41).

6. Flexible connection element, in particular scales compensator (1), according to claim 5, further comprising an other annular stabilization element (37, 47) which at least abuts on the surface (36, 46), which faces away from the face (35, 45), of the respective flange (33, 43), wherein, in case of intended attaching of the respective flange (33, 43) to the connection flange, the clamp directly abuts on the other annular stabilization element (37, 47).

7. Flexible connection element, in particular scales compensator (1), according to claim 5, wherein an elevation (38, 48) which encircles the corresponding opening is formed on the face of the respective flange (33, 43) and which sits, in case of intended attaching of the respective flange (33, 43) by means of the clamp, in a corresponding recess formed in the connection flange and which acts as a seal.

8. Flexible connection element, in particular scales compensator (1), according to claim 5, wherein a recess, which encircles the corresponding opening, is formed in the face of the flange and in which a corresponding elevation formed on the connection flange sits, in case of intended attaching of the flange (33, 43) by means of the clamp, and wherein the elevation acts as a seal.

9. Method of producing a base body for a flexible connection element which is designated for connecting a first device with a second device and for passing through a bulk material from the first device into the second device, wherein the base body comprises
a first end portion at which an inlet opening is formed and which, in case of intended use of the flexible connection element, is attached to the first device such that the bulk material can enter the conveyance channel through the inlet opening, and
a second end portion at which an outlet opening is formed and which is, in case of intended use of the flexible connection element, attached to the second device such that the bulk material can exit the conveyance channel through the outlet opening into the second device, wherein
the first and second end portion of the base body each define a flange extending outwards in a radial direction, wherein in each of the flanges a reception space is defined which encircles the corresponding opening, and a dimensionally stable stabilization element can be changeably inserted in the respective reception space such that, in case of intended attaching of the corresponding end portion, a clamping force generated by a fastening means acts on the stabilization element; wherein the method comprises the following steps:
a forming step in which the base body is completely formed of the flexible material, for example cast from the flexible material, such that the respective reception space, in which the respective stabilization element can be inserted through the respective insertion opening, is formed at the first and second end portion.
